(19) United States
(12) Patent Application Publication
(10) Pub. No.: US 2025/0315725 A1
(43) Pub. Date: Oct. 9, 2025

(54) SYSTEMS AND METHODS FOR MITIGATING THE OVERFITTING OF ARTIFICIAL INTELLIGENCE MODELS

(71) Applicant: Wells Fargo Bank, N.A., San Francisco, CA (US)

(72) Inventors: Shahnam Khabiri, Falls Church, VA (US); Jia Gao, Charlotte, NC (US)

(21) Appl. No.: 18/630,785

(22) Filed: Apr. 9, 2024

(51) Int. Cl. G06N 20/00

(52) U.S. Cl. CPC G06N 20/00

(57) ABSTRACT

Systems, apparatuses, methods, and computer program products are disclosed for providing overfitting mitigation for AI models under training. An example method includes initiating a model training session for an AI model. The example method further includes determining an overfitting metric value associated with an overfitting metric, where the overfitting metric indicates an overfitting condition associated with an AI model under training. The example method further includes determining whether the overfitting metric value satisfies a first overfitting metric threshold and determining whether the overfitting condition associated with the AI model has deteriorated. The example method further includes, in response to determining that the overfitting condition associated with the AI model has deteriorated, incrementing a patience counter value associated with a patience counter, determining whether the patience counter value satisfies a patience threshold and, in response to determining that the patience counter value satisfies the patience threshold, terminating the model training session.

### BACKGROUND

One of the fundamental challenges in training large artificial intelligence (AI) models is trading off between complexity and generalization. This trade-off is evaluated in the concepts of overfitting and underfitting, both of which are critical aspects of AI model training that impact the performance of the final AI model.

### BRIEF SUMMARY

The employment of AI models is becoming ubiquitous amongst enterprises operating across various knowledge domains (e.g., financial, scientific, academic, and commercial domains). Large language models (LLMs), natural language processing (NLP) models, deep learning models, and the like have vastly increased in popularity due to their ability to comprehend, generate, and/or manipulate human language. However, training such models is a difficult and computationally expensive task, and successfully training AI models to be appropriately complex yet also able to perform well on unseen input data is a fundamental challenge in the AI field.

The ideal outcome of training, for example, an LLM model is for the model to perform equally well on both training data as well as new, unseen data. It may be desirable to have a generalized AI model capable of performing well on both training data and unseen data, but various assumptions that are made in a modeling function to generalize the training process lead to an error rate in the training data commonly referred to as bias. In contrast, a complex model with more flexibility to fit the training data leads to a difference in the error rates of the training data and the error rates of validation data (e.g., test data). This difference is referred to as model variance. A more generalized (or “underfit”) model typically has a higher bias and lower variance to balance the performance of the model between both seen and unseen data, whereas an “overfit” model may have a low bias and high variance.

Overfitting occurs when an AI model's complexity increases, and the AI model starts to memorize the training data instead of learning the underlying patterns. As a result, the AI model performs well on the training data but fails to produce the same results for unseen data. Overfitting is a common issue in training AI models which have a large number of parameters with significant complexity. In some scenarios, a small amount of data and/or model complexity are the main reasons for a model overfit. Conventional AI model training systems may be configured to address overfitting by increasing the amount of training data, reducing the complexity of the AI model, employing “early stopping” during the training of the AI model, utilizing ridge and lasso regularization, and/or employing random dropout (e.g., model feature dropout) and weight decay methods.

To address overfitting and other technological problems associated with training of an AI model, example embodiments described herein comprise an AI model overfitting mitigation system configured to monitor and control the training process of one or more AI models. In example embodiments, the AI model overfitting mitigation system may, at least in part, initiate a model training session for the AI model and, for each model training epoch of a plurality of model training epochs associated with the model training session: (i) determine a value associated with an overfitting metric, where the overfitting metric indicates an overfitting condition associated with the AI model; (ii) determine whether the value associated with the overfitting metric satisfies a first overfitting metric threshold; (iii) in response to determining that the value associated with the overfitting metric satisfies the first overfitting metric threshold, determine, based on the value associated with the overfitting metric, whether the overfitting condition associated with the AI model has deteriorated; (iv) in response to determining that the overfitting condition associated with the AI model has deteriorated, increment a patience counter value associated with a patience counter; (v) determine whether the patience counter value satisfies a patience threshold, and (vi) in response to determining that the patience counter value satisfies the patience threshold, terminate the model training session for the AI model.

Accordingly, the present disclosure sets forth systems, methods, and apparatuses that provide AI model overfitting mitigation. There are many advantages of these, and other embodiments described herein. One advantage which the AI model overfitting mitigation system provides is an improvement to the functioning of the computing infrastructure of an enterprise by reducing the burden on computing resources. For instance, the AI model overfitting mitigation system described herein reduces the complexity of training an AI model by dynamically terminating the training of the AI model at an optimal time so as to ensure the AI model is not overfit, by, among other things, automating processes such as measuring the overfitting condition of the AI model and terminating the training of the AI model before the overfitting condition deteriorates to an unsuitable level.

This not only provides the benefit of ensuring that the AI model is not overfit, but also reduces the consumption of technological resources by ensuring that the training process does not run for an unnecessarily long time. Additionally, terminating the training of the AI model at before the AI model is overfit further provides the benefit of ensuring that the AI model is also not underfit, nor undertrained. Furthermore, the AI model overfitting mitigation system provides improvements to the field of AI technology. For example, terminating a training process at the most optimal time (e.g., when the AI model is no longer at risk of being underfit and before the AI model is overfit), provides the technological benefit of ensuring that the AI model is trained to generate the most accurate, desired model output based on unseen data in an efficient manner.

Example embodiments may achieve the aforementioned benefits by determining an overfitting metric value associated with an overfitting metric that indicates an overfitting condition associated with a respective AI model during training. The overfitting metric disclosed herein provides more sensitivity to the dynamics of overfitting while training an AI model than conventional AI model training systems. As described herein, the overfitting metric may be defined as validationLoss/trainLoss, which is the ratio of validation loss, which indicates how well the AI model fits validation data (e.g., test data), and training loss, which indicates how well the AI model fits the training data.

Example embodiments also employ a double-threshold overfit scheme that utilizes a dynamic, “return-to-zero” counting approach (a.k.a. an incremental counting overfit scheme) that interacts with a gradient of the overfitting metric during the training of an AI model. In such example embodiments, a patience counter tracks the number of model training epochs (e.g., training iterations) in which a gradient value associated with the gradient of the overfitting metric is positive gradient value. A positive gradient value indicates the deterioration (e.g., increase) of the overfitting condition and persistently positive gradient values indicate an incremental increase in the value of overfitting metric over the course of an AI model's training. Some example embodiments may be configured to continuously compare the overfitting metric value to a first overfitting metric threshold (e.g., a lower bound) and increment a patience counter value for each model training epoch that the overfitting metric value satisfies (e.g., meets or exceeds) the first overfitting metric threshold. As such, example embodiments may terminate the training of the AI model if it is determined that the patience counter value has satisfied (e.g., met or exceeded) a value associated with a patience threshold. In the event the gradient value associated with the gradient of the overfitting metric is a negative gradient value (i.e., the overfit condition improves), the patience counter value may be reset to zero and the model training will continue. As such, example embodiments provide the technological benefit of being sensitive to improvements in the overfitting metric and will not terminate the training of an AI model prematurely as would be the case with conventional model training systems that employ an “early stopping” overfit scheme.

In addition to monitoring the first overfitting metric threshold (e.g., the lower bound), the double-threshold overfit scheme of example embodiments is further configured to prevent overfitting “roll-off,” or runaway. In other words, the double-threshold overfit scheme ensures that the model training is terminated before the AI model is overfit. In this regard, example embodiments may be configured to define and/or monitor a second overfitting metric threshold (e.g., an upper bound) to detect when the overfitting condition has deteriorated to unacceptable levels and/or is deteriorating at a high rate. In such example embodiments, the AI model overfitting mitigation system may be configured to abruptly terminate the training of a respective AI model if it is determined that an overfitting metric value associated with the aforementioned overfitting metric satisfies (e.g., meets or exceeds) a value associated with the second overfitting metric threshold (e.g., the upper bound).

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating an AI model overfitting mitigation system.

FIG. 2 illustrates a schematic block diagram of example circuitry embodying a system device that may perform various operations in accordance with some example embodiments described herein.

FIG. 3 illustrates model training analysis results associated with various overfitting metric configurations monitored during a model training session in accordance with some example embodiments described herein.

FIG. 4 illustrates model training analysis results associated with a single-threshold overfit scheme employed during a model training session in accordance with some example embodiments described herein.

FIG. 5 illustrates model training analysis results associated with a double-threshold overfit scheme employed during a model training session in accordance with some example embodiments described herein.

FIG. 6 illustrates model training analysis results comparing the performance of a single-threshold overfit scheme and a double-threshold overfit scheme utilizing a differential overfitting metric during a model training session in accordance with some example embodiments described herein.

FIG. 7 illustrates model training analysis results comparing the performance of a single-threshold overfit scheme and a double-threshold overfit scheme utilizing an overfitting metric ratio during a model training session in accordance with some example embodiments described herein.

FIG. 8 illustrates a flowchart associated with example operations for mitigating the overfitting of an AI model during a model training session in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “user device” or “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

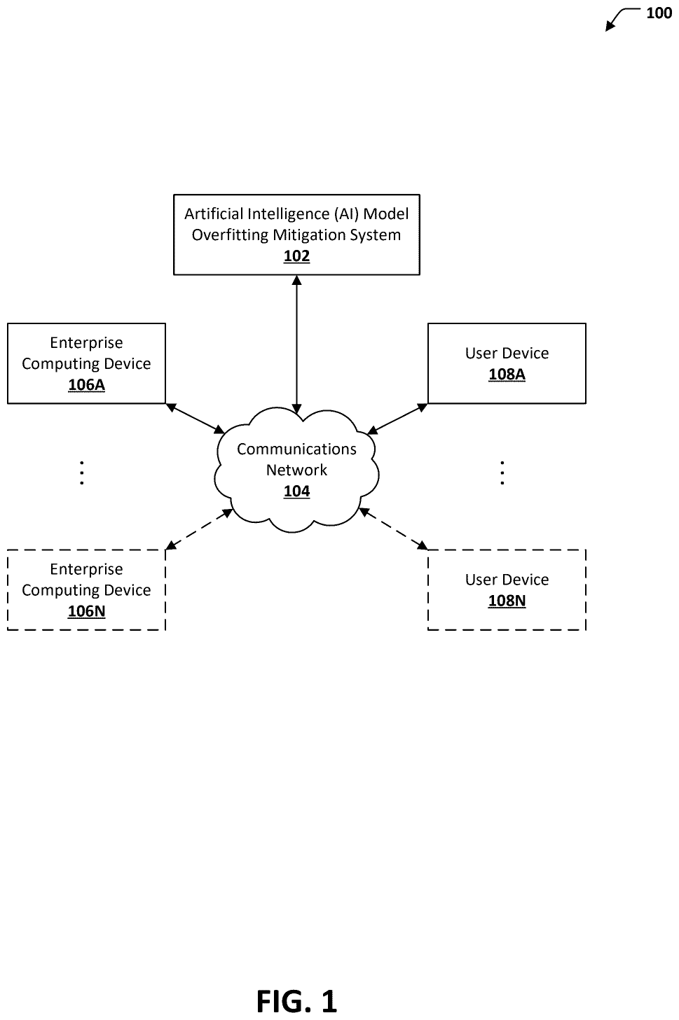

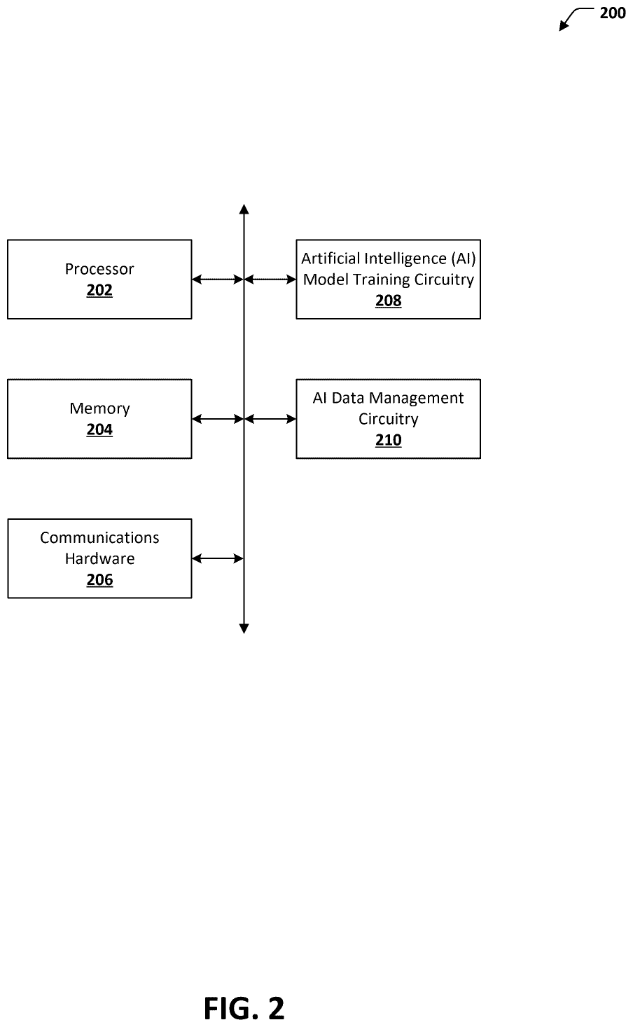

Example embodiments described herein may be implemented using any of a variety of computing devices or servers. To this end, FIG. 1 illustrates an example environment 100 within which various embodiments may operate. As illustrated, an AI model overfitting mitigation system 102 may receive and/or transmit information via communications network 104 (e.g., the Internet) with any number of other devices, such as one or more of enterprise computing devices 106A-106N and/or user devices 108A-108N. The AI model overfitting mitigation system 102 may be implemented as one or more computing devices or servers, which may be composed of a series of components. Particular components of the AI model overfitting mitigation system 102 are described in greater detail below with reference to apparatus 200 in connection with FIG. 2.

In various embodiments, the AI model overfitting mitigation system 102 may be associated with an enterprise (e.g., a financial institution, bank, and/or the like) and may be configured to manage various AI model training processes. For example, the AI model overfitting mitigation system 102 may be configured to manage, execute, initiate, and/or otherwise facilitate one or more AI model training processes, underfitting mitigation processes, overfitting mitigation processes, overfitting metric configuration processes, overfitting condition monitoring processes, model training session monitoring processes, overfitting metric threshold definition processes, and/or the like.

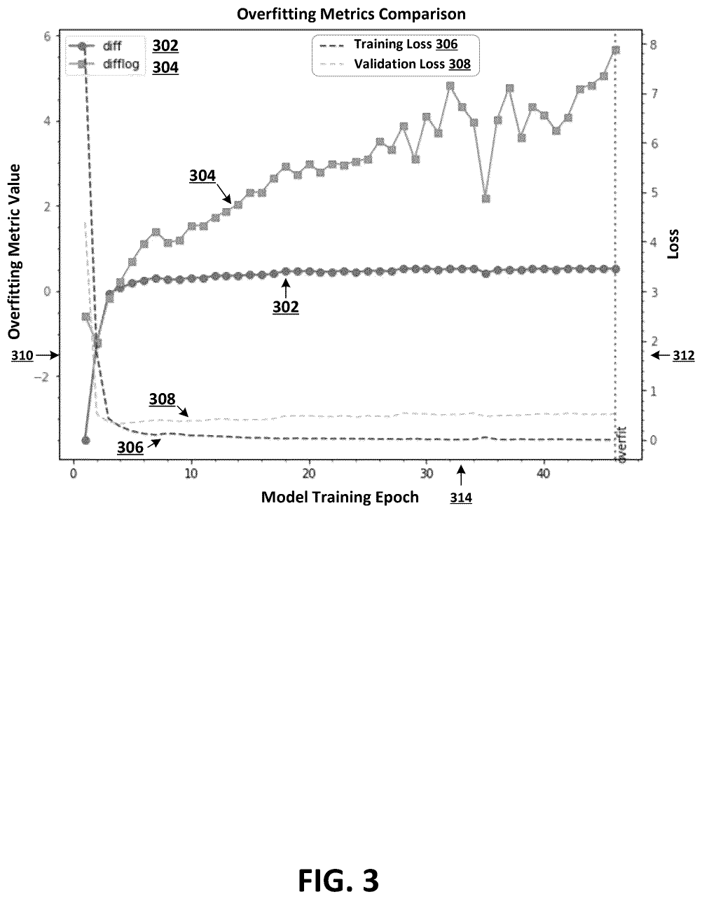

In one or more embodiments, the AI model overfitting mitigation system 102 may be configured to detect and/or mitigate the overfitting of an AI model during a model training session by employing a double-threshold overfit scheme. In this regard, the AI model overfitting mitigation system 102 may be configured to continuously monitor an overfitting metric value associated with an overfitting metric that indicates a current overfitting condition of an AI model during a model training session. In various embodiments, the AI model overfitting mitigation system 102 may be configured to compare the overfitting metric value to one or more overfitting metric thresholds (e.g., a lower bound and/or upper bound) to determine when to terminate the model training session at point in which the AI model is optimally trained (i.e., when the AI model is neither underfit, nor overfit). These and other operations will be described in further detail herein below with reference to FIGS. 3-8.

In some embodiments, the AI model overfitting mitigation system 102 may be configured to monitor and/or facilitate the training of a plurality of model types. For example, the AI model overfitting mitigation system 102 may be configured to train several types of models configured to execute various machine learning (ML), machine vision (MV), AI, generative AI, natural language processing (NLP), and/or optical character recognition (OCR) techniques. For example, the AI model overfitting mitigation system 102 may be configured to facilitate the training and/or overfitting mitigation for one or more supervised or unsupervised models configured as an LLM, artificial neural network (ANN), recurrent neural network (RNN), convolutional neural network (CNN), long short-term memory (LSTM) network, transformer model, rules-based model, or any other suitable deep learning model.

In some embodiments, the AI model overfitting mitigation system 102 further includes a storage device that comprises a distinct component from other components of the AI model overfitting mitigation system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally or alternatively, the storage device may host the software executed to operate the AI model overfitting mitigation system 102. Additionally or alternatively, the storage device may store information relied upon during operation of the AI model overfitting mitigation system 102, such as various data including, but not limited to, AI model training data, AI model validation data (e.g., test data), AI model input data (e.g., unseen data, testing data, training data), AI model output data (e.g., result data), AI model error data (e.g., training loss data, validation loss data, overfitting metric data, underfitting metric data), and/or the like configured in various data formats to be utilized by the AI model overfitting mitigation system 102. In addition, the storage device may store control signals, device characteristics, and/or access credentials enabling interaction between the AI model overfitting mitigation system 102 and/or one or more of the enterprise computing devices 106A-106N or user devices 108A-108N.

In various embodiments, the one or more enterprise computing devices 106A-106N and/or the one or more user devices 108A-108N may be embodied by any computing devices known in the art. The one or more enterprise computing devices 106A-106N and/or the one or more user devices 108A-108N need not themselves be independent devices but may be peripheral devices communicatively coupled to other computing devices.

### Example Implementing Apparatuses

The AI model overfitting mitigation system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 2-8. As illustrated in FIG. 2, the apparatus 200 may include processor 202, memory 204, communications hardware 206, AI model training circuitry 208, and/or AI data management circuitry, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application instance (e.g., a mobile application), dedicated client device, or the like. In some embodiments, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises AI model training circuitry 208. In some embodiments, the AI model training circuitry 208 may be configured to facilitate the execution of one or more model training, overfitting mitigation, and/or underfitting mitigation operations for an enterprise associated with the AI model overfitting mitigation system 102. Additionally, the AI model training circuitry 208 may utilize processor 202, memory 204, AI data management circuitry 210, and/or any other hardware component included in the apparatus 200 to perform these operations, as described in connection with FIGS. 3-8 below.

The AI model training circuitry 208 may further utilize the communications hardware 206 to gather data from, or transmit data to, a variety of sources (e.g., enterprise computing devices 106A-106N, user devices 108A-108N, social media networks, server systems, and/or any storage devices associated with the AI model overfitting mitigation system 102), and/or exchange data with a user. In some embodiments, the AI model training circuitry 208 may work in conjunction with (e.g., may direct and/or otherwise manage) the AI data management circuitry 210 in order to execute one or more of the methods described herein. For example, in some embodiments, the AI model training circuitry 208 may integrate with and/or otherwise leverage the AI data management circuitry 210 to employ various data (e.g., training data, validation data) to determine a current overfitting condition associated with an AI model during a model training session. Based in part on the overfitting condition associated with the AI model, the AI model training circuitry 208 may terminate the model training session at a time before which the AI model becomes overfit. Further details related to these, and other operations will be described in further detail herein below with reference to FIGS. 3-8.

In addition, the apparatus 200 further comprises AI data management circuitry 210 that may be configured to facilitate the management and/or utilization of various data associated with a respective enterprise by various components associated with the AI model overfitting mitigation system 102. The AI data management circuitry 210 may utilize processor 202, memory 204, or any other hardware component included in the apparatus 200 to perform these operations, as described in connection with FIGS. 3-8 below. The AI data management circuitry 210 may further utilize communications hardware 206 to gather data from a variety of sources (e.g., enterprise computing devices 106A-106N, user devices 108A-108N, and/or any storage devices associated with the AI model overfitting mitigation system 102), and/or exchange data with a user, and in some embodiments may utilize processor 202 and/or memory 204 to receive, retrieve, parse, process, store, update, delete, and/or otherwise manage one or more portions of data relied upon during operation of the AI model overfitting mitigation system 102. For example, the AI data management circuitry 210 may manage various data including, but not limited to, AI model training data, AI model validation data (e.g., test data), AI model input data (e.g., unseen data, testing data, training data), AI model output data (e.g., result data), AI model error data (e.g., training loss data, validation loss data, overfitting metric data, underfitting metric data), and/or the like configured in various data formats to be utilized by the AI model overfitting mitigation system 102. In some embodiments, the AI data management circuitry 210 may work in conjunction with the AI model training circuitry 208 and/or one or more storage devices associated with the AI model overfitting mitigation system 102 in order to execute one or more of the methods described herein. These and other operations associated with the AI data management circuitry 210 will be described in further detail herein below with reference to FIGS. 3-8.

Although components 202-210 are described in part using functional language, it will be understood that the particular implementations necessarily include the use of particular hardware. It should also be understood that certain of these components 202-210 may include similar or common hardware. For example, the AI model training circuitry 208 and/or the AI data management circuitry 210 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the AI model training circuitry 208 and/or the AI data management circuitry 210 may leverage processor 202, memory 204, and/or communications hardware 206 as described above, it will be understood that any of the AI model training circuitry 208 and/or AI data management circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the AI model training circuitry 208 and/or AI data management circuitry 210 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example AI Model Overfitting Mitigation Analysis

The overfitting condition (a.k.a. model overfit) of an AI model can be understood as a noted diversion of training loss (i.e., error) and validation loss during the training of the AI model. Traditionally, model overfit has been quantified by the equation validationLoss−trainLoss, where validationLoss indicates how well the AI model fits (e.g., performs on) validation data (e.g., test data), and where trainLoss indicates how well the AI model fits the training data. In various examples, the validation loss may be an error value quantifying one or more errors made by an AI model when using model validation data as input data, and the training loss may be an error value quantifying one or more errors made by the AI model when using training data as input data. However, because the value of trainLoss can potentially be very small, the differential loss between validationLoss and trainLoss cannot appropriately capture the severity of an overfitting condition associated with an AI model under training.

To deal with this issue, instead of utilizing the differential loss, example embodiments described herein contemplate monitoring an overfitting metric defined as validationLoss/trainLoss, or alternatively monitoring a differential logarithmic overfitting metric defined as log(validationLoss)−log(trainLoss) (which is equivalent to the ratio validationLoss/trainLoss but on a logarithmic scale) of over the course of a model training session associated with an AI model. As will be described further herein, the overfitting metric validationLoss/trainLoss contemplated by example embodiments is more sensitive to the changes in the overfitting condition of an AI model, as the conventional differential loss equation, validationLoss−trainLoss, relies on absolute values which can change from one model training session to another, and does not detect minute improvements and/or deteriorations in the overfitting condition of the AI model.

FIGS. 3-7 illustrate AI model training analysis results associated with the transfer learning and fine-tuning of a pretrained transformer-based optical character recognition (TrOCR) model that was trained for 46 model training epochs during respective model training sessions. However, it should be appreciated that the methods and/or AI model training analysis results described herein with reference to FIGS. 3-7 may also apply to the training of various other types of AI models that the AI model overfitting mitigation system 102 may be configured to train and/or monitor as described herein. Accordingly, the AI model training analysis results described herein with reference to operational and/or example embodiments are presented for purposes of explanation and not of limitation.

FIG. 3 depicts a graph illustrating model training analysis results associated with various overfitting metric configurations monitored during a model training session. As shown in FIG. 3, secondary y-axis 312 shows the respective values of training loss 306 and validation loss 308 which correspond to a numerical value associated with the errors made by the AI model based on the input of respective training data sets and validation data sets. Primary y-axis 310 shows the overfitting metric value of the selected metrics utilized to quantify the severity of an overfitting condition related to the AI model under training, and the values corresponding to x-axis 314 denote the progression of a plurality of model training epochs associated with the model training session.

Overfitting metric 302, labeled as diff, is defined as validationLoss−trainLoss (e.g., a numerical value associated with the difference between the values of validation loss 308 and training loss 306). Because the loss value for training loss 306 is often very small, the difference of loss values does not show the extent of the overfitting condition of an AI model. Additionally, the differential value associated with the overfitting metric 302 is conventionally related to the absolute value of loss, which varies from one type of model to another. Therefore, the differential loss metric (e.g., overfitting metric 302) cannot be generalized and used to detect an overfitting condition in different scenarios.

Overfitting metric 304 illustrated in the graph depicted in FIG. 3, labeled as difflog, is defined as log(validationLoss)−log(trainLoss) which is equivalent to the ratio validationLoss/trainLoss (e.g., a numerical value associated with the ratio of the value of validation loss 308 to the value of training loss 306) but on a logarithmic scale. As shown by the line associated with the overfitting metric 304 (difflog), the overfitting metric value of difflog noticeably increases towards the end of the model training session, suggesting the onset of a deteriorating overfitting condition, whereas the overfitting metric 302 (diff) is not sensitive to the change in the overfitting condition of the AI model. As described herein, the overfitting metric value of difflog (e.g., overfitting metric 304) relies on the ratio of validation loss to training loss rather than relying on absolute error values which may change from one model training session to another. As such, the normalized values of the ratio of validation loss to training loss allows for generalizing the usage of difflog for different model training sessions.

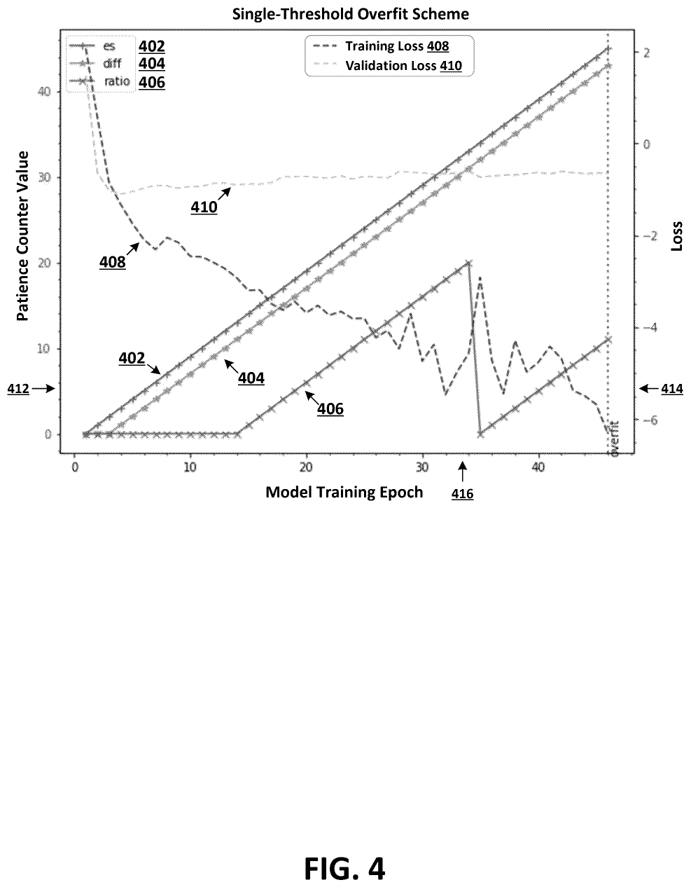

Turning now to FIG. 4, FIG. 4 further illustrates the benefit of using an overfitting metric related to the ratio of validation loss to training loss to monitor the overfitting condition of a respective AI model during a model training session. In particular, FIG. 4 illustrates model training analysis results associated with a single-threshold overfit scheme employed during a model training session. In some embodiments, the AI model overfitting mitigation system 102 may be configured to determine whether to employ one or more overfitting metric thresholds. In various other embodiments, the AI model overfitting mitigation system 102 may configure an AI model training session based in part on a model training session configuration request that indicates whether to employ a single-threshold overfit scheme or a double-threshold overfit scheme.

As shown in FIG. 4, a single-threshold overfit scheme has been employed for a respective model training session in which only a single overfitting metric threshold (e.g., a lower bound) is used. Also as shown in FIG. 4, the secondary y-axis 414 (e.g., the loss axis) shows the respective values of training loss 408 and validation loss 410 which correspond to a numerical value associated with the errors made by the AI model based on the input of respective training and validation data sets. As shown, the secondary y-axis 414 is plotted based on a logarithmic scale which serves to enhance the visualization and monitoring of the loss variations of the training loss 408 and the validation loss 410. Primary y-axis 412 indicates the value of a patience counter relative to a particular overfitting metric 402-406, and the values corresponding to x-axis 416 denote the progression of a plurality of model training epochs associated with the model training session. As described herein, in various embodiments, a patience counter value associated with a patience counter may be incremented for each model training epoch in a model training session that an overfitting metric value satisfies (e.g., meets or exceeds) a first overfitting metric threshold. As such, example embodiments may terminate the training of the AI model if it is determined that the patience counter value has satisfied (e.g., met or exceeded) a value associated with a patience threshold. Additionally, the patience counter value associated with the patience counter may be reset upon a determination that an overfitting metric value does not satisfy (e.g., meets or exceeds) a first overfitting metric threshold.

In this regard, the AI model training circuitry 208 may be configured to determine if an overfitting metric value (e.g., a numerical value or the like associated with the overfitting metrics 402-406) satisfies an overfitting metric threshold (e.g., a numerical value or the like). The overfitting metric value may satisfy the respective overfitting metric threshold if the overfitting metric value is greater than or equal to the respective overfitting metric threshold (e.g., to within an error value of ±1%, ±5%, or any other number). In other examples, the overfitting metric value (e.g., a numerical value or the like) may satisfy the respective overfitting metric threshold (e.g., a numerical value or the like) if the overfitting metric value is less than or equal to the respective overfitting metric threshold (e.g., to within an error value of ±1%, ±5%, or any other number).

FIG. 4 shows the performance of overfitting metric 404, labeled as diff, which is defined as validationLoss−trainLoss (e.g., a numerical value associated with the difference between the values of validation loss 410 and training loss 408), and overfitting metric 406, labeled as ratio, which is defined as validationLoss/trainLoss (e.g., a numerical value associated with the ratio of the value of validation loss 410 to the value of training loss 408) for a single-threshold overfit scheme. FIG. 4 also illustrates the performance of overfitting metric 402 related to an “early stopping” callback, es, which is widely used in deep learning frameworks and is included herein as a reference. As it is known, the early stopping callback (e.g., overfitting metric 402) only monitors the validation loss (e.g., validation loss 410) of an AI model under training and stops a respective model training session once there has not been a certain amount of improvement in the validation loss for a specific number of consecutive model training epochs (e.g., five, ten, twenty, or any suitable number of model training epochs).

By focusing only on the validation loss (e.g., validation loss 410) and ignoring training loss (e.g., training loss 408), the early stopping callback metric (e.g., overfitting metric 402) may fail to accurately capture an overfitting condition or an underfitting condition associated it the AI model. In a scenario in which the validation loss and the training loss associated with a respective AI model both reduce, but in which the training loss reduces at a greater pace, the AI model will be at risk of becoming overfit, yet the early stopping callback, es, would fail to detect the overall deteriorating overfitting condition of the AI model. In another scenario, if both the validation loss (e.g., validation loss 410) and the training loss (e.g., training loss 408) are not sufficiently improving, an early stopping callback scheme may determine to terminate a respective model training session while the AI model is left underfit.

As shown in FIG. 4, the patience counter values associated with the various overfitting metrics es, diff, and ratio (e.g., indicated by primary y-axis 412) are triggered (e.g., incremented) when the respective overfitting metric threshold is satisfied. As depicted, the patience counter value associated with the early stopping callback (e.g., overfitting metric 402) continues to increase as the validation loss 410 fails to improve beyond the respective overfitting metric threshold. Additionally, diff (e.g., overfitting metric 404) increases at every model training epoch as diff lacks enough sensitivity to detect the intermittent improvement that takes place at model training epoch 35. However, the overfitting metric 406 associated with ratio successfully detects the intermittent improvement in the overfitting condition of the AI model, and by resetting the respective patience counter at model training epoch 35, the AI model training session is allowed to continue for a longer time such that the AI model is optimally trained be neither underfit nor overfit.

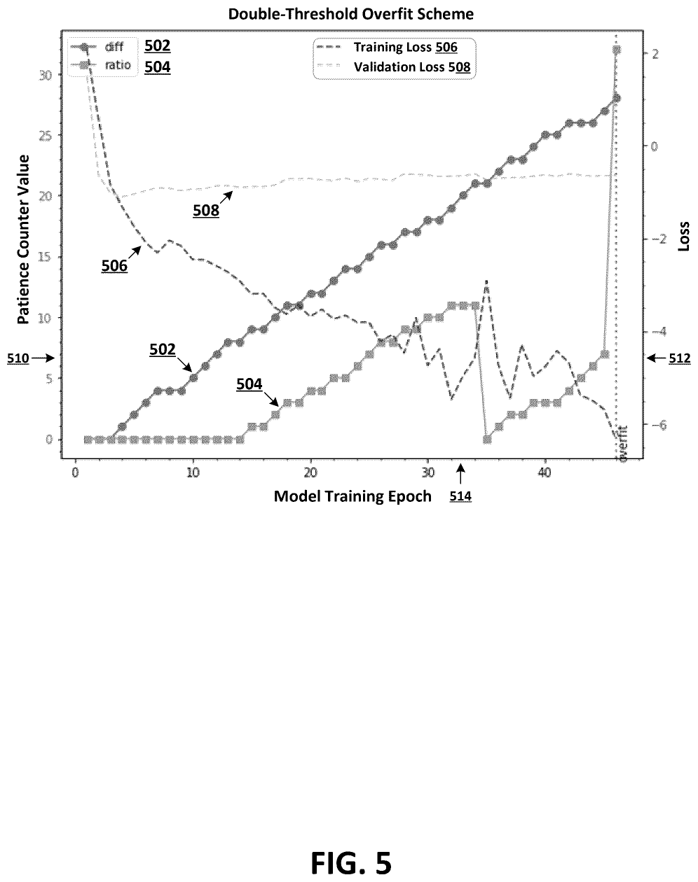

However, as depicted, towards the end of the model training session where the overfitting condition rapidly deteriorates, the patience counter associated with ratio (e.g., overfitting metric 406) fails to stop the model training session and allows the overfitting condition to roll off to detrimental levels. This is due in part to the configuration of the single-threshold overfit scheme as well as the earlier reset of the patience counter value associated with ratio (e.g., overfitting metric 406). For example, because the single-threshold overfit scheme utilizes only a single overfitting metric threshold (e.g., a lower bound), there is a heightened risk of overfit roll off. As such, the patience counter in the single-threshold overfit scheme is configured to operate in one of two ways: increment a patience counter value when the value of a respective overfitting metric (e.g., ratio or diff) satisfies the single overfitting metric threshold (e.g., the lower bound), or reset the patience counter value to zero when the value of the respective overfitting metric (e.g., ratio or diff) does not satisfy the single overfitting metric threshold. As will be described in more detail herein with reference to FIG. 5, the configuration of the patience counter in the single-threshold overfit scheme inherently prioritizes reducing the risk of overfit roll off and captures less historical context of the loss variations of the training loss (e.g., training loss 408) and the validation loss (e.g., validation loss 410) over the course of a respective model training session. To improve upon the limitations of the single-threshold overfit scheme, various embodiments implement a double-threshold overfit scheme configured to mitigate overfit roll off while preserving the historical context of the loss variations of the training loss (e.g., training loss 408) and the validation loss (e.g., validation loss 410) over the course of a respective model training session.

Turning now to FIG. 5, FIG. 5 illustrates model training analysis results associated with a double-threshold overfit scheme employed during a model training session. As shown in FIG. 5, the secondary y-axis 512 (e.g., the loss axis) shows the respective values of training loss 506 and validation loss 508 which correspond to a numerical value associated with the errors made by the AI model based on the input of respective training and validation data sets. As shown, the secondary y-axis 512 is plotted based on a logarithmic scale which serves to enhance the visualization and monitoring of the loss variations of the training loss 506 and the validation loss 508. Primary y-axis 510 indicates the value of a patience counter relative to a particular overfitting metric 502-504, and the values corresponding to x-axis 514 denote the progression of a plurality of model training epochs associated with the model training session.

In the double-threshold overfit scheme, there are two overfitting metric thresholds that are utilized (e.g., a lower bound and an upper bound). There is also a patience counter configured to keep track of the overfitting condition of a respective AI model under training. The patience counter is triggered (e.g., a patience counter value is incremented) when an overfitting metric value for a given overfitting metric (e.g., overfitting metrics 502-504 associated with diff and ratio respectively) exceeds a first overfitting metric threshold (e.g., a lower bound) for a respective model training epoch of a plurality of model training epochs associated with a respective model training session.

In various embodiments, as long as a gradient value associated with a gradient corresponding to the overfitting metric is a positive value, the patience counter value increments. In some embodiments, if the gradient value associated with the gradient corresponding to the overfitting metric (e.g., overfitting metric 504) is a zero gradient (i.e., the overfitting condition remains the same from the previous model training epoch), or is a negative gradient value (i.e., the overfitting condition improves), the patience counter value remains the same. In this manner, the historical context of the loss variations of the training loss (e.g., training loss 506) and the validation loss (e.g., validation loss 508) over the course of a respective model training session is preserved. This preservation of the historical context of the loss variations by the double-threshold overfit scheme is indicated by the “staircase” shape of the gradients related to the overfitting metrics illustrated in FIG. 5 (e.g., overfitting metrics 502-504). Additionally, if an overfitting metric value associated with a respective overfitting metric (e.g., overfitting metric 504) drops below the first overfitting metric threshold (e.g., the overfitting condition greatly improves), the respective patience counter is reset to zero. The second overfitting metric threshold (e.g., the upper bound) is utilized as a safety mechanism to terminate a respective model training session if the overfitting metric value satisfies (e.g., meets or exceeds) a value associated with the second overfitting metric threshold.

FIG. 5 illustrates the performance of the double-threshold overfit scheme employed by various embodiments using different overfitting metrics, notably overfitting metric 502, labeled as diff, and overfitting metric 504, labeled as ratio, both of which are similarly defined to overfitting metrics 404-406 defined herein with respective to FIG. 4. As depicted in FIG. 5 and as described herein, the overfitting metric 502 (diff) has insufficient capability to track an overfitting condition of an AI model under training due in part to the fact that the overfitting metric 502 (diff) relies on absolute values. As shown, once the overfitting metric value associated with the overfitting metric 502 (diff) crosses the first overfitting metric threshold (e.g., the lower bound), the line representing the patience counter for the overfitting metric 502 continues to rise in a staircase fashion. As illustrated, overfitting metric 502 (diff) does not detect the sudden improvement in the overfitting condition associated with the AI model at model training epochs 34-36. As such, utilizing an overfitting metric such as diff poses the risk of terminating the training prematurely as the patience counter value associated with diff may satisfy a respective patience threshold. This lack of sensitivity is also evident at the end of the model training session where the overfitting condition suddenly deteriorates at model training epochs 44-46, yet the overfitting metric value associated with overfitting metric 502 (diff) does not cross the upper bound overfit threshold.

In contrast, as illustrated by the line associated with the overfitting metric 504 (ratio), the intermittent improvement in the overfitting condition at model training epochs 34-36 is successfully detected and causes the corresponding patience counter value to be reset to zero. Moreover, the overfitting metric 504 (ratio) reacts to the sudden drop in training loss at the end of the model training session. Said differently, the AI model training circuitry 208 detected that the overfitting metric value associated with overfitting metric 504 (ratio) exceeded the second overfitting metric threshold (e.g., the upper bound) and abruptly terminated the respective model training session.

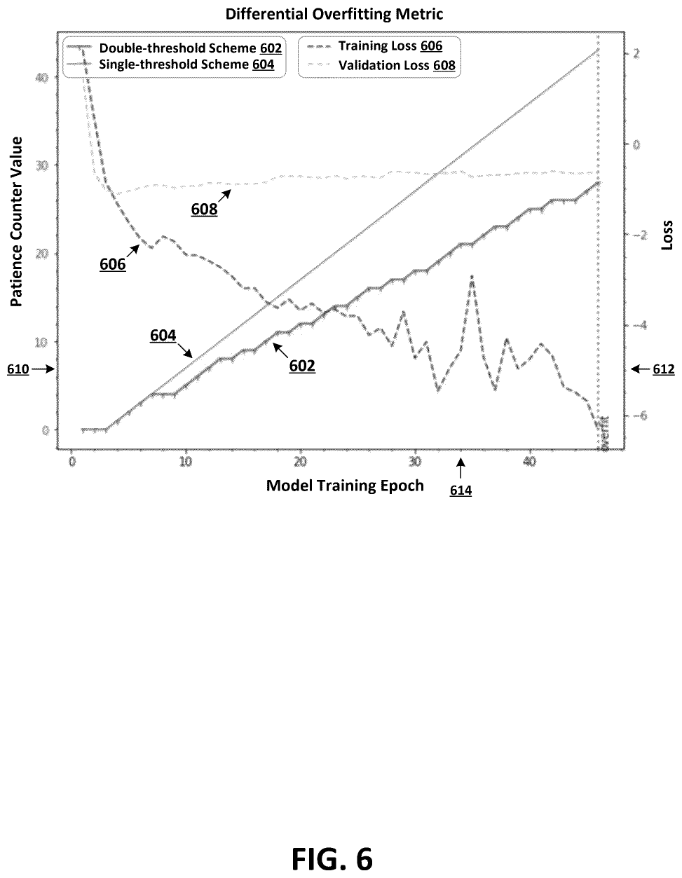

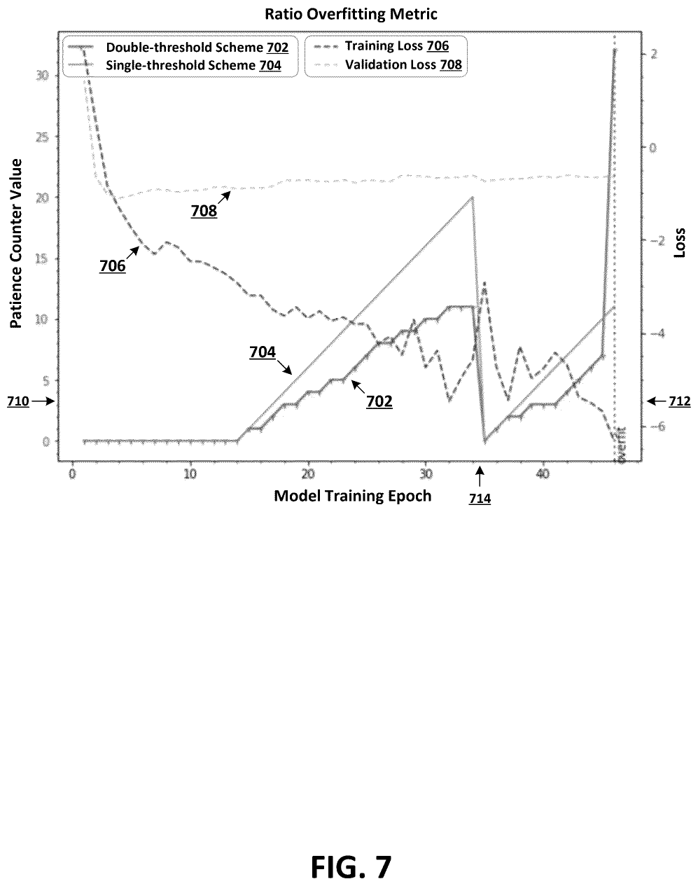

FIGS. 6 and 7 illustrate model training analysis results that compare the performance of a single-threshold overfit scheme to a double-threshold overfit scheme based on the utilization of particular overfitting metrics. For example, FIG. 6 illustrates model training analysis results that compare the performance of a double-threshold overfit scheme 602 and a single-threshold overfit scheme 604 utilizing a differential overfitting metric (e.g., diff, which is defined as validationLoss−trainLoss (e.g., a numerical value associated with the difference between the values of validation loss 608 and training loss 606)) during a model training session. As shown in FIG. 6, the secondary y-axis 612 (e.g., the loss axis) shows the respective values of training loss 606 and validation loss 608 which correspond to a numerical value associated with the errors made by the AI model based on the input of respective training and validation data sets. As shown, the secondary y-axis 612 is plotted based on a logarithmic scale which serves to enhance the visualization and monitoring of the loss variations of the training loss 606 and the validation loss 608. Primary y-axis 610 indicates the value of a patience counter relative to a particular overfit scheme (e.g., double-threshold overfit scheme 602 and single-threshold overfit scheme 604), and the values corresponding to x-axis 614 denote the progression of a plurality of model training epochs associated with the model training session.

As depicted in FIG. 6, the lines associated with the double-threshold overfit scheme 602 and the single-threshold overfit scheme 604 illustrate the advantage of employing a double-threshold overfit scheme (e.g., double-threshold overfit scheme 602) in which a patience counter associated with the respective overfitting metric (e.g., diff, as defined herein) takes the gradient of the overfitting metric into account and does not indiscriminately increment the patience counter value based on the overfitting condition (e.g., as further illustrated herein with reference to FIG. 4). However, as described herein, the differential overfitting metric (e.g., diff, as defined herein) metric provides neither sensitivity nor control to reliably identify the overfit roll-off at the end of the respective model training session. As such, the second threshold associated with the double-threshold overfit scheme 602 (e.g., the upper bound) is never reached and the model training session is not terminated at the appropriate time.

FIG. 7 illustrates model training analysis results that compare the performance of a double-threshold overfit scheme 702 and a single-threshold overfit scheme 704 utilizing an overfitting metric associated with a ratio of validation loss (e.g., validation loss 708) to training loss (e.g., training loss 706) such as ratio, which is defined as validationLoss/trainLoss (e.g., a numerical value associated with the ratio of the value of validation loss 708 to the value of training loss 706) during a respective model training session. As shown in FIG. 7, the secondary y-axis 712 (e.g., the loss axis) shows the respective values of training loss 706 and validation loss 708 which correspond to a numerical value associated with the errors made by the AI model based on the input of respective training and validation data sets. As shown, the secondary y-axis 712 is plotted based on a logarithmic scale which serves to enhance the visualization and monitoring of the loss variations of the training loss 706 and the validation loss 708. Primary y-axis 710 indicates the value of a patience counter relative to a particular overfit scheme (e.g., double-threshold overfit scheme 702 and single-threshold overfit scheme 704), and the values corresponding to x-axis 714 denote the progression of a plurality of model training epochs associated with the model training session.

Due to the increased sensitivity of an overfitting metric such as ratio to detect the overfitting condition of the AI model under training, both the double-threshold overfit scheme 702 and the single-threshold overfit scheme 704 successfully detect the intermittent improvement in the overfitting condition that takes place at model training epoch 35 and reset the respective patience counters to zero. The double-threshold overfit scheme 702, by taking the gradient of the ratio overfitting metric (e.g., ratio) into account is observant of the overfitting condition, leading to a more controlled AI model training session. Additionally at the end of the AI model training session where the overfitting condition of the AI model suddenly deteriorates at model training epochs 44-46, the ratio overfitting metric (e.g., ratio) helps to detect the overfitting condition roll-off in which the overfitting metric value satisfies the second overfitting metric threshold (e.g., the upper bound) and consequently brings the AI model training session to an abrupt end.

### Example Operations

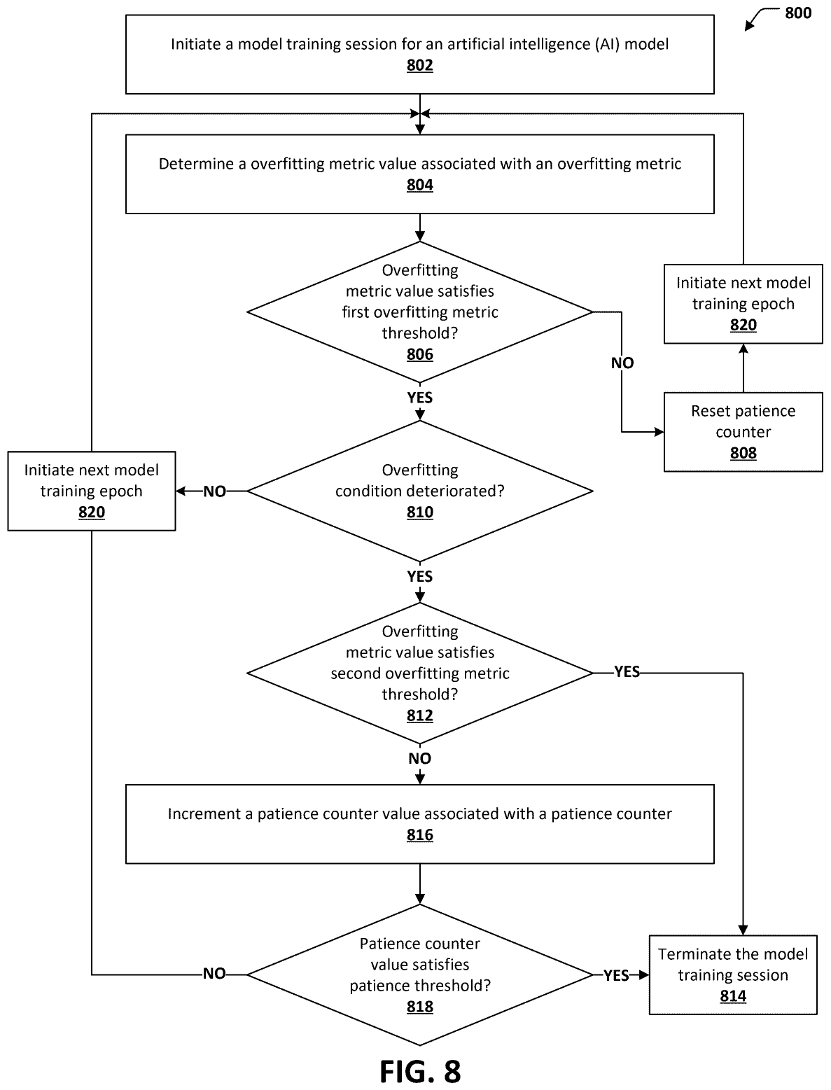

FIG. 8 depicts a flowchart 800 detailing example operations for mitigating the overfitting of an AI model during a model training session. The operations illustrated in FIG. 8 may, for example, be performed by a system device (e.g., server, etc.) of the AI model overfitting mitigation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, AI model training circuitry 208, AI data management circuitry 210, and/or any combination thereof. It will be understood that user interaction with the AI model overfitting mitigation system 102 may occur directly via communications hardware 206 or may instead be facilitated by a separate computing device (e.g., any of enterprise computing devices 106A-106N, and/or user devices 108A-108N shown in FIG. 1), and which may have similar or equivalent physical componentry facilitating such user interaction.

According to various embodiments, one or more of the operations 804-820 as described herein with reference to FIG. 8 may be performed in whole or in part during one or more model training epochs of a plurality of model training epochs of a respective AI model training session associated with a particular AI model. Alternatively, in various embodiments, one or more of the operations 804-820 as described herein may be omitted and/or skipped for one or more model training epochs of a plurality of model training epochs of a respective AI model training session associated with a particular AI model.

As shown by operation 802, the apparatus 200 may include means, such as processor 202, memory 204, communications hardware 206, AI model training circuitry 208, and/or the like for initiating a model training session for an AI model. For example, the AI model training circuitry 208 may be configured to initiate and/or facilitate one or more AI model training sessions for one or more respective AI models. In various examples, an AI model training session may be a first (e.g., initial) AI model training session for a respective AI model, or the AI model training session may be a second AI model training the respective AI model (e.g., a retraining, refining, and/or fine-tuning of the AI model.) As described herein, a respective AI model training session may be comprised of a plurality of model training epochs, or model training iterations. The plurality of model training epochs may be executed in sequential order and may be configured to iteratively train, update, refine, and/or test a respective AI model based on one or more of training data, validation data, testing data, and/or unseen data.

In some embodiments, a respective AI model training session may be initiated and/or configured based on a model training session configuration request. For example, the AI model training circuitry 208 may be configured to initiate and/or configure the AI model training session based on a model training session configuration request received by the communications hardware 206 from a user device (e.g., user device 108A). In various embodiments, a respective model training session configuration request may comprise one or more of a preferred number of model training epochs for the plurality of model training epochs, a first defined value for the first overfitting metric threshold (e.g., a lower bound), a second defined value for a second overfitting metric threshold (e.g., an upper bound), and/or a third defined value for a patience threshold associated with the AI model training session. Additionally or alternatively, in some embodiments, the model training session configuration request may indicate whether the AI model training circuitry 208 should employ a single-threshold overfit scheme or a double-threshold overfit scheme for the respective AI model training session. Furthermore, in various embodiments, the model training session configuration request may define a particular overfitting metric to be employed during the AI model training session (e.g., overfitting metric 504 associated with ratio, as defined herein).

As shown by operation 804, the apparatus 200 may include means, such as processor 202, memory 204, AI model training circuitry 208, AI data management circuitry 210, and/or the like for determining an overfitting metric value associated with an overfitting metric. As described herein, the overfitting metric value of an overfitting metric indicates a current overfitting condition associated with the AI model. For example, the AI model training circuitry 208 may be configured to monitor an overfitting metric (e.g., overfitting metric 504 (ratio)) which is defined as validationLoss/trainLoss to determine an overfitting metric value for a respective model training epoch of a plurality of model training epochs associated with a model training session. Accordingly, the overfitting metric value may be a numerical value (e.g., a quotient value) associated with the ratio of the value of validation loss (e.g., validation loss 508) to the value of training loss (e.g., training loss 506). The values of training loss (e.g., training loss 506) and validation loss (e.g., validation loss 508) may be error values quantifying one or more errors made by the AI model based on the input of respective training data sets and validation data sets. Alternatively, in various other embodiments, the AI model training circuitry 208 may be configured to monitor a differential logarithmic overfitting metric defined as log(validationLoss)−log(trainLoss) (which is equivalent to the ratio validationLoss/trainLoss but on a logarithmic scale).

In various embodiments, the AI data management circuitry 210 may be configured to manage (e.g., process, parse, update, delete, transmit, etc.) one or more training data sets, validation data sets, and/or other various data sets to be employed by the AI model training circuitry 208 during a respective model training session to determine the overfitting metric value for a given model training epoch.

As shown by operation 806, the apparatus 200 may include means, such as processor 202, memory 204, AI model training circuitry 208, and/or the like for determining whether the value associated with the overfitting metric satisfies a first overfitting metric threshold. For example, the AI model training circuitry 208 may be configured to determine if an overfitting metric value (e.g., a numerical value or the like associated with an overfitting metric (e.g., overfitting metric 504) satisfies an overfitting metric threshold (e.g., a numerical value or the like). The overfitting metric value may satisfy the respective overfitting metric threshold if the overfitting metric value is greater than or equal to the respective overfitting metric threshold (e.g., to within an error value of ±1%, ±5%, or any other number). In other examples, the overfitting metric value (e.g., a numerical value or the like) may satisfy the respective overfitting metric threshold (e.g., a numerical value or the like) if the overfitting metric value is less than or equal to the respective overfitting metric threshold (e.g., to within an error value of ±1%, ±5%, or any other number).

In various examples, the AI model training circuitry 208 may be configured to employ a double-threshold overfit scheme associated with a first and second overfitting metric threshold (e.g., a lower bound and an upper bound). In such embodiments, if the AI model training circuitry 208 determines that a current overfitting metric value does not satisfy the first overfitting metric threshold (e.g., the lower bound), the AI model training circuitry 208 may proceed to operation 808 in which a patience counter is reset to zero. However, if the overfitting metric value does satisfy the first overfitting metric threshold, the AI model training circuitry 208 may proceed to operation 810 in which the overfitting condition of the AI model is evaluated.

As shown by operation 808, the apparatus 200 may include means, such as processor 202, memory 204, AI model training circuitry 208, and/or the like for resetting the patience counter associated with the AI model overfitting mitigation system 102. In various embodiments, the AI model training circuitry 208 may be configured to continuously compare the overfitting metric value to the first overfitting metric threshold (e.g., a lower bound) and increment a patience counter value for each model training epoch that the overfitting metric value satisfies (e.g., meets or exceeds) the first overfitting metric threshold. In such embodiments, the AI model training circuitry 208 may determine a value for the patience counter that limits the number of model training epochs that are performed for a given model training session.

The use of the patience counter ensures that the model training session does not run too long and/or that the AI model is not continually trained, re-trained, and/or refined with an unacceptable (e.g., deteriorating) overfitting condition for more than a certain number of model training epochs. However, if over the course of the model training session the overfitting condition of the AI model improves to the point that the overfitting metric value does not satisfy the first overfitting metric threshold (e.g., the lower bound), the patience counter may be reset such that the model training session is extended, thereby giving the AI model training circuitry 208 additional time to train, re-train, and/or refine the AI model which may result in a better quality AI model. This example scenario is illustrated and described herein with reference to FIG. 5. In various embodiments, once the AI model training circuitry 208 resets the value of the patience counter, the AI model training circuitry 208 may be configured to proceed to operation 820 in which a next model training epoch of the plurality of model training epochs is initiated.

As shown by operation 810, the apparatus 200 may include means, such as processor 202, memory 204, AI model training circuitry 208, and/or the like for determining whether the overfitting condition associated with the AI model has deteriorated. In some embodiments, a gradient associated with the overfitting metric (e.g., overfitting metric 504) may be used in part to determine whether the overfitting condition of the AI model has deteriorated. For example, the AI model training circuitry 208 may be configured to determine whether a gradient value associated with a gradient corresponding to the overfitting metric (e.g., overfitting metric 504) is a positive gradient value or a negative gradient value for a given model training epoch of the plurality of model training epochs associated with the model training session. In such embodiments, a positive gradient value indicates a deterioration of the overfitting condition, and a negative gradient value indicates an improvement of the overfitting condition.

In some embodiments, if a gradient value associated with a gradient of the overfitting metric (e.g., overfitting metric 504) is a negative gradient value or zero gradient value for a given model training epoch (i.e., the overfitting condition of the AI model has not deteriorated since the last model training epoch), the AI model training circuitry 208 may proceed to operation 820 in which it may initiate the next model training epoch of the model training session. However, if a gradient value associated with a gradient of the overfitting metric (e.g., overfitting metric 504) is a positive gradient value for a given model training epoch (i.e., the overfitting condition of the AI model has deteriorated since the last model training epoch), the AI model training circuitry 208 may proceed to operation 812.

As shown by operation 812, the apparatus 200 may include means, such as processor 202, memory 204, AI model training circuitry 208, and/or the like for determining whether the overfitting metric value satisfies a second overfitting metric threshold. For example, the AI model training circuitry 208 may be configured to determine whether the overfitting metric value associated with the overfitting metric (e.g., overfitting metric 504) satisfies the second overfitting metric threshold (e.g., an upper bound) of the double-threshold overfit scheme. The second overfitting metric threshold (e.g., the upper bound) is utilized as a safety mechanism to terminate a respective model training session if the overfitting metric value associated with a given model training epoch satisfies (e.g., meets or exceeds) a value associated with the second overfitting metric threshold. As such, if the AI model training circuitry 208 determines that the overfitting metric value satisfies the second overfitting metric threshold, it may proceed to operation 814 in which the model training session is abruptly terminated, and the current state of the AI model is preserved. However, if the AI model training circuitry 208 determines that the overfitting metric value does not satisfy the second overfitting metric threshold, it may proceed to operation 816.

As shown by operation 814, the apparatus 200 may include means, such as processor 202, memory 204, AI model training circuitry 208, AI data management circuitry 210, and/or the like for terminating the model training session. As described herein, the AI model training circuitry 208 may be configured to terminate a model training session during a given model training epoch based on various conditions associated the AI model and/or the model training session itself. For example, the AI model training circuitry 208 may terminate the model training session upon determining that an overfitting metric value associated with a particular overfitting metric (e.g., overfitting metric 504) satisfies (e.g., meets or exceeds) a second overfitting metric threshold (e.g., an upper bound) during the execution of a given model training epoch. Additionally or alternatively, the AI model training circuitry 208 may be configured to terminate the model training session based on a determination that a patience counter value has satisfied (e.g., met or exceeded) a patience threshold.

In various embodiments, the AI model training circuitry 208 may be configured to abruptly terminate the model training session during execution of a given model training epoch before the model training epoch has completed. In various other embodiments, the AI model training circuitry 208 may be configured to terminate the model training session after completion of a respective model training epoch during which one or more conditions for termination have been met (e.g., an overfitting metric value satisfies the second overfitting metric threshold, the patience counter value satisfies a patience threshold, etc.).

In various embodiments, the AI model training circuitry 208 may leverage the AI data management circuitry 210 to preserve a current state of the AI model (e.g., a current level of training, re-training, and/or refinement) upon termination of the model training session. Additionally, the AI model training circuitry 208 may leverage the AI data management circuitry 210 to cause storage of one or more portions of data related to the training of the AI model that was generated, captured, received, and/or otherwise determined during the respective model training session including, but not limited to, AI model training data, AI model validation data (e.g., test data), AI model input data (e.g., unseen data, testing data, training data), AI model output data (e.g., result data), AI model error data (e.g., training loss data, validation loss data, overfitting metric data, underfitting metric data), and/or the like.

As shown by operation 816, the apparatus 200 may include means, such as processor 202, memory 204, AI model training circuitry 208, and/or the like for incrementing a patience counter value associated with the patience counter. For example, upon determining that the overfitting condition associated with the AI model has deteriorated yet the overfitting metric value has not satisfied the second overfitting metric threshold (e.g., has not met or exceeded an upper bound), the AI model training circuitry 208 may be configured to increment a patience counter value associated with a patience counter.

In various embodiments, the AI model training circuitry 208 may increment the patience counter value associated with the patience counter based on determining that a gradient value associated with the gradient corresponding to the overfitting metric is a positive gradient value. In such embodiments, the AI model training circuitry 208 may employ the patience counter to track the number of model training epochs (e.g., training iterations) in which a gradient value associated with the gradient of the overfitting metric is positive gradient value. A positive gradient value indicates the deterioration (e.g., increase) of the overfitting condition of the AI model, and persistently positive gradient values indicate an incremental increase in the value of overfitting metric over the course of a model training session.

As shown by operation 818, the apparatus 200 may include means, such as processor 202, memory 204, AI model training circuitry 208, and/or the like for determining whether a current patience counter value associated with the patience counter satisfies a patience threshold. For example, the AI model training circuitry 208 may be configured to determine whether the patience counter value satisfies a patience threshold for a respective model training session. If the AI model training circuitry 208 determines that the patience counter value satisfies the patience threshold, the AI model training circuitry 208 may proceed to operation 814 in which it may terminate the training of the AI model. Alternatively, if the AI model training circuitry 208 determines that the patience counter value does not satisfy the patience threshold, the AI model training circuitry may proceed to operation 820 and cause initiation of a next model training epoch associated with a respective model training session.

As shown by operation 820, the apparatus 200 may include means, such as processor 202, memory 204, AI model training circuitry 208, and/or the like for initiating a next model training epoch of a plurality of model training epochs associated with a respective model training session. As described herein, the AI model training circuitry 208 may be configured to cause the initiation of a next model training epoch of the plurality of model training epochs associated with the current model training session.

FIG. 8 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide systems, methods, and apparatuses that enable improved AI model training. Example embodiments thus provide tools that overcome the problems faced by conventional AI model training systems which, in some scenarios, require additional attention and effort on the part of the user to determine whether a particular AI model has been underfit or overfit during a model training session. Furthermore, example embodiments employ a novel overfitting metric and an innovative double-threshold overfit scheme to ensure that an overfitting condition of a particular AI model stays within acceptable limits. By avoiding the use of conventional AI model training mechanisms, example embodiments thus save time and resources, while also eliminating the possibility of an AI model being overfit to the training and/or validation data used to train the AI model.

For instance, example embodiments provide protection against the waste of computational resources by ensuring that the training of an AI model does not go on any longer than is necessary to achieve an optimal level of training, re-training, and/or refinement. Furthermore, the embodiments described herein improve the field of AI technology in general as the embodiments described herein are configured to abruptly terminate the training of an AI model upon a determination that an overfitting condition of the AI model has exacerbated to unacceptable levels, and/or is at risk of “rolling off.” This ensures that the AI model is not overfit and produces the desired results when using unseen data as model input.

Moreover, by employing an overfitting metric that monitors a ratio of the validation loss and the training loss of a particular AI model in conjunction with a patience counter of a double-threshold overfit scheme, example embodiments also ensure that respective model training sessions are not terminated prematurely. This ensures that an AI model is not undertrained and/or underfit, thus improving the quality of the AI models trained and/or re-trained using the various embodiments described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for mitigating overfitting during training of an artificial intelligence (AI) model, the method comprising:
initiating, by AI model training circuitry, a model training session for the AI model; and
for each model training epoch of a plurality of model training epochs associated with the model training session:
determining, by the AI model training circuitry, an overfitting metric value associated with an overfitting metric, wherein the overfitting metric indicates an overfitting condition associated with the AI model,
determining, by the AI model training circuitry, whether the overfitting metric value satisfies a first overfitting metric threshold, and
in response to determining that the overfitting metric value satisfies the first overfitting metric threshold:
determining, by the AI model training circuitry and based on the overfitting metric value, whether the overfitting condition associated with the AI model has deteriorated; and
in response to determining that the overfitting condition associated with the AI model has deteriorated:
incrementing, by the AI model training circuitry, a patience counter value associated with a patience counter,
determining, by the AI model training circuitry, whether the patience counter value satisfies a patience threshold, and
in response to determining that the patience counter value satisfies the patience threshold, terminating, by the AI model training circuitry, the model training session for the AI model.

2. The method of claim 1, wherein determining whether the overfitting condition associated with the AI model has deteriorated comprises:
determining, by the AI model training circuitry, whether a gradient value associated with a gradient corresponding to the overfitting metric is a positive gradient value or a negative gradient value for a given model training epoch of the plurality of model training epochs associated with the model training session,
wherein a positive gradient value indicates a deterioration of the overfitting condition, and wherein a negative gradient value indicates an improvement of the overfitting condition.

3. The method of claim 2, wherein the patience counter value associated with the patience counter is incremented based on determining that the gradient value associated with the gradient corresponding to the overfitting metric is a positive gradient value.

4. The method of claim 1, the method further comprising:
in response to determining that the overfitting metric value does not satisfy the first overfitting metric threshold:
resetting, by the AI model training circuitry, the patience counter value associated with the patience counter.

5. The method of claim 1, the method further comprising:
for each model training epoch of the plurality of model training epochs associated with the model training session:
determining, by the AI model training circuitry, whether the overfitting metric value satisfies a second overfitting metric threshold; and
in response to determining that the overfitting metric value satisfies the second overfitting metric threshold:
terminating, by the AI model training circuitry, the model training session for the AI model.

6. The method of claim 1, wherein the overfitting metric is a ratio of validation loss to training loss, wherein the validation loss is an error value quantifying one or more errors made by the AI model when using model validation data as input data, and wherein the training loss is an error value quantifying one or more errors made by the AI model when using training data as input data.

7. The method of claim 1, the method further comprising:
receiving, by communications hardware and prior to initiating the model training session for the AI model, a model training session configuration request associated with the model training session for the AI model,
wherein the model training session configuration request comprises one or more of a preferred number of model training epochs for the plurality of model training epochs, a first defined value for the first overfitting metric threshold, a second defined value for a second overfitting metric threshold, or a third defined value for the patience threshold, and
wherein the model training session is initiated based on the model training session configuration request.

8. An apparatus for mitigating overfitting during training of an artificial intelligence (AI) model, the apparatus comprising:
AI model training circuitry configured to:
initiate a model training session for the AI model;
for each model training epoch of a plurality of model training epochs associated with the model training session, determine an overfitting metric value associated with an overfitting metric, wherein the overfitting metric indicates an overfitting condition associated with the AI model;
determine whether the overfitting metric value satisfies a first overfitting metric threshold; and
in response to determining that the overfitting metric value satisfies the first overfitting metric threshold, determine, based on the overfitting metric value, whether the overfitting condition associated with the AI model has deteriorated;
in response to determining that the overfitting condition associated with the AI model has deteriorated:
increment a patience counter value associated with a patience counter;
determine whether the patience counter value satisfies a patience threshold; and
in response to determining that the patience counter value satisfies the patience threshold:
terminate the model training session for the AI model.

9. The apparatus of claim 8, wherein determining whether the overfitting condition associated with the AI model has deteriorated further causes the AI model training circuitry to:
determine whether a gradient value associated with a gradient corresponding to the overfitting metric is a positive gradient value or a negative gradient value for a given model training epoch of the plurality of model training epochs associated with the model training session,
wherein a positive gradient value indicates a deterioration of the overfitting condition, and wherein a negative gradient value indicates an improvement of the overfitting condition.

10. The apparatus of claim 9, wherein the patience counter value associated with the patience counter is incremented based on determining that the gradient value associated with the gradient corresponding to the overfitting metric is a positive gradient value.

11. The apparatus of claim 8, wherein the AI model training circuitry is further configured to:
in response to determining that the overfitting metric value does not satisfy the first overfitting metric threshold:
reset the patience counter value associated with the patience counter.

12. The apparatus of claim 8, wherein the AI model training circuitry is further configured to:
for each model training epoch of the plurality of model training epochs associated with the model training session:
determine whether the overfitting metric value satisfies a second overfitting metric threshold; and
in response to determining that the overfitting metric value satisfies the second overfitting metric threshold:
terminate the model training session for the AI model.

13. The apparatus of claim 8, wherein the overfitting metric is a ratio of validation loss to training loss, wherein the validation loss is an error value quantifying one or more errors made by the AI model when using model validation data as input data, and wherein the training loss is an error value quantifying one or more errors made by the AI model when using training data as input data.

14. The apparatus of claim 8, wherein the apparatus further comprises:
communications hardware configured to:
receive, prior to initiating the model training session for the AI model, a model training session configuration request associated with the model training session for the AI model,
wherein the model training session configuration request comprises one or more of a preferred number of model training epochs for the plurality of model training epochs, a first defined value for the first overfitting metric threshold, a second defined value for a second overfitting metric threshold, or a third defined value for the patience threshold, and
wherein the AI model training circuitry is further configured to initiate the model training session based on the model training session configuration request.

15. A computer program product for mitigating overfitting during training of an artificial intelligence (AI) model, the computer program product comprising at least one non-transitory computer-readable storage medium storing software instructions that, when executed, cause an apparatus to:
initiate a model training session for the AI model;
for each model training epoch of a plurality of model training epochs associated with the model training session, determine an overfitting metric value associated with an overfitting metric, wherein the overfitting metric indicates an overfitting condition associated with the AI model;
determine whether the overfitting metric value satisfies a first overfitting metric threshold;
in response to determining that the overfitting metric value satisfies the first overfitting metric threshold:
determine, based on the overfitting metric value, whether the overfitting condition associated with the AI model has deteriorated, and
in response to determining that the overfitting condition associated with the AI model has deteriorated:
increment a patience counter value associated with a patience counter;
determine whether the patience counter value satisfies a patience threshold; and
in response to determining that the patience counter value satisfies the patience threshold, terminate the model training session for the AI model.

16. The computer program product of claim 15, wherein the software instructions configured to determine whether the overfitting condition associated with the AI model has deteriorated further cause the apparatus to:
determine whether a gradient value associated with a gradient corresponding to the overfitting metric is a positive gradient value or a negative gradient value for a given model training epoch of the plurality of model training epochs associated with the model training session,
wherein a positive gradient value indicates a deterioration of the overfitting condition, and wherein a negative gradient value indicates an improvement of the overfitting condition.

17. The computer program product of claim 16, wherein the patience counter value associated with the patience counter is incremented based on determining that the gradient value associated with the gradient corresponding to the overfitting metric is a positive gradient value.

18. The computer program product of claim 15, wherein the software instructions further cause the apparatus to:
in response to determining that the overfitting metric value does not satisfy the first overfitting metric threshold:
reset the patience counter value associated with the patience counter.

19. The computer program product of claim 15, wherein the software instructions further cause the apparatus to:
for each model training epoch of the plurality of model training epochs associated with the model training session:
determine whether the overfitting metric value satisfies a second overfitting metric threshold; and
in response to determining that the overfitting metric value satisfies the second overfitting metric threshold:
terminate the model training session for the AI model.

20. The computer program product of claim 15, wherein the overfitting metric is a ratio of validation loss to training loss, wherein the validation loss is an error value quantifying one or more errors made by the AI model when using model validation data as input data, and wherein the training loss is an error value quantifying one or more errors made by the AI model when using training data as input data.
